(19) United States
(12) Patent Application Publication
(10) Pub. No.: US 2013/0282512 A1
(43) Pub. Date: Oct. 24, 2013

(54) METHOD AND SYSTEM OF SELECTING AN AGENT

(71) Applicant: Antony David Summerfield, Brighton (AU)

(72) Inventor: Antony David Summerfield, Brighton (AU)

(73) Assignee: Real Estate Agent Select Pty Ltd, Brighton (AU)

(21) Appl. No.: 13/866,438

(22) Filed: Apr. 19, 2013

(30) Foreign Application Priority Data
Apr. 19, 2012 (AU) 2012901543

(51) Int. Cl. G06Q 30/06

(52) U.S. Cl. CPC G06Q 30/0611
USPC 705/26.4

(57) ABSTRACT

A method of selecting a real estate company using a computer-based network (100) to sell a property asset of a vendor or vendor representative, the method including the steps of obtaining information from the vendor or representative about the asset using information entry means (200) available from a server (104) in the computer-based network (100) and storing the information on the server (104); referring a plurality of agencies in the vicinity of the location of the property asset to be sold; enabling the referred agencies to assess the value of the asset; obtaining a tender submission from the referred agencies using tender submission entry means (600) available from the server (104) in the computer-based network (100); enabling the vendor or representative to review each tender submission; and the vendor or representative selecting an agency from the referred agencies to sell the asset based on the reviewed tender submissions.

### FOREIGN PRIORITY

This application claims the right of foreign priority to Application No. 2012901543 filed in Australia on Apr. 19, 2012, by the same inventors, which is incorporated herein by reference in its entirety.

### BACKGROUND

1. Field of the Invention

This invention relates to a method and system of selecting a real estate company and more particularly relates to a method and system of selecting a real estate company to sell an asset on behalf of a vendor.

2. Background of the Invention

Traditionally, in order for a person or vendor to sell property, he or she in most instances would use a real estate agent to sell the property on their behalf. For the vendor to select an appropriate real estate company, there is no systematic method. Usually the vendor would approach real estate companies who sell property in the area where the property intended for sale is located. It is highly possible that by not asking the correct questions or having some methodology, then the value of the property intended for sale may not be understood. It is highly possible that by not spending enough time to research many real estate companies or ask appropriate questions to better assess them, the agency eventually selected may not estimate an accurate value, could be charging an excessive commission fee or otherwise not be looking after the interests of the vendor. Typically a person or vendor, after choosing a real estate company, will be bound by a written agreement to which they are legally required to comply with various terms and conditions, some of which can be quite onerous. They will be bound by the particular sales method and marketing proposed by the real estate company sales representative often without having much say in how this is performed. Furthermore, it is always difficult to arrange convenient inspection times with prospective real estate agents in order for them to better understand the property to be sold. It is possible that where more than two agents are being assessed to undertake the sale on behalf of a person or vendor, they will often dictate inspection times which may not entirely be convenient to the person or vendor.

The present invention seeks to overcome one or more of the disadvantages by providing a method and system of selecting a suitable real estate company based on a number of criteria and most of which are performed electronically. The system provides a framework whereby a person or vendor can compare best performing real estate companies and make a better informed selection decision.

### SUMMARY

According to a first aspect of the invention, there is provided a method of selecting an agency using a computer-based network to sell a property asset of a vendor or representative of the vendor, the method including the steps of:

obtaining information from the vendor about the asset using information entry means available from a server in the computer-based network and storing the information on the server;

referring a plurality of agencies in the vicinity of the location of the property to be sold;

enabling the referred agencies to assess the value of the property;

obtaining a tender submission from the referred agencies using tender submission entry means available from the server in the computer-based network;

enabling the vendor or representative to review each tender submission; and

the vendor or representative selecting an agency from the referred agencies to sell the asset based on the reviewed tender submissions.

According to a second aspect of the invention, there is provided computer program means, when executed on a processor, in a method of selecting an agency to sell a property asset of a vendor or representative of the vendor, instructs the processor to:

provide information entry means for the vendor or representative to information on the property asset;

store the information;

provide a tender submission entry means for referred agencies from a plurality of agencies to complete a tender submission related to the property asset;

enable the vendor or representative to review each tender submission;

wherein the vendor or representative selects an agency from the referred agencies to sell the property asset based on the reviewed tender submissions.

According to a third aspect of the invention, there is provided a computer-based network used to select an agency to sell a property asset of a vendor or representative of the vendor, the network including:

a server having information entry means for enabling the vendor or representative to enter information on the asset and register with the network;

said server having tender submission entry means enabling referred agencies from a plurality of agencies in the vicinity of the location of the property asset to provide a tender submission;

whereupon review of each tender submission by the vendor or representative, the vendor or representative selects an agency from the referred agencies to sell the property asset.

According to a fourth aspect of the invention, there is provided a computer program product for enabling selection of an agent to sell a property asset of a vendor or vendor representative, said computer program product including at least one computer-readable storage medium having computer-readable code portions stored therein, the computer-readable program portions having:

a first executable portion for providing information entry means for the vendor or vendor representative to provide information about the asset which information in subsequently stored;

a second executable portion for providing a tender submission entry means for referred agencies from a plurality of agencies to complete a tender submission related to the property asset;

a third executable portion for enabling the vendor or vendor representative to review each tender submission;

wherein the vendor or vendor representative selects an agency from the referred agencies to sell the property asset based on the reviewed tender submissions.

According to a fifth aspect of the invention, there is provided a computer-useable medium having a computer-readable program code embodied therein, said computer-readable program code adapted to be executed to implement a method of selecting an agent to sell a property asset of a vendor or vendor representative, by:

providing information entry means for the vendor or vendor representative to provide information about the asset;

storing the information;

providing a tender submission entry means for referred agencies from a plurality of agencies to complete a tender submission related to the property asset;

enabling the vendor or vendor representative to review each tender submission;

wherein the vendor or vendor representative selects an agency from the referred agencies to sell the property asset based on the reviewed tender submissions.

### BRIEF DESCRIPTION OF THE DRAWINGS

A preferred embodiment of the invention will hereinafter be described, by way of example only, with reference to the drawings in which:

FIG. 1 is a block diagram of a computer-based network used by a vendor or representative of the vendor to select an agency, such as a real estate company, or an agent/representative of the agency to sell a property asset according to an embodiment of the invention;

FIG. 1A is a screen view of the home page of a website of a third party that enables a vendor to select one or more agents to sell an asset of the vendor;

FIGS. 2A to 2D are screen views of an information entry means from the website of the third party to enable a vendor or vendor representative to register the asset;

FIG. 2E is a screen view showing a message received by the vendor or representative after registering;

FIG. 2F is a screen view of a login page used by the vendor or representative to access a registrant dashboard at the website of the third party;

FIG. 2G is a screen view of the registrant dashboard;

FIGS. 2H and 2J are screen views providing the vendor or representative access to tender submissions from each referred real estate company and enabling selection of a preferred real estate company;

FIG. 3 is a screen view of a referral authority for each referred real estate company to complete and submit;

FIG. 3A is a screen view of a login page, similar to FIG. 2F, used by each real estate company to access an agency dashboard at the website of the third party;

FIG. 4 is a screen view of the agency dashboard when the real estate company representative accesses the referral form;

FIG. 5 is a screen view of the agency dashboard when the real estate company representative accesses a tender submission entry means to provide information in order to complete the tender;

FIGS. 6A to 6D are four portions of a single screen view or page of a tender submission entry means accessed through the agency dashboard or received by email;

FIG. 7 is a screen view of the agency dashboard relating to the pending selection of a real estate company by the vendor or representative;

FIG. 8 is a screen view of the agency dashboard relating to the pending sales authority after the real estate company has been selected;

FIG. 9 is a screen view accessed by the vendor or representative after the real estate company has been selected;

FIG. 10 is a screen view enabling the selected real estate company to upload and view information pertaining to the proposed sale of the asset;

FIG. 11 is a screen view of the agency dashboard relating to the pending sales data from the real estate company;

FIG. 12 is a screen view similar to FIG. 10 confirming the entered or uploaded information;

FIG. 13 is a screen view of the agency dashboard relating to the pending settlement of the property asset;

FIG. 14 is a screen view similar to FIG. 12 redisplaying the uploaded information;

FIG. 15 is a flow diagram describing the process of selecting a real estate company by the vendor or representative using the website of the third party; and

FIG. 16 is a further alternative flow diagram describing the process of selecting a real estate company by the vendor or representative using the website of the third party.

### DETAILED DESCRIPTION

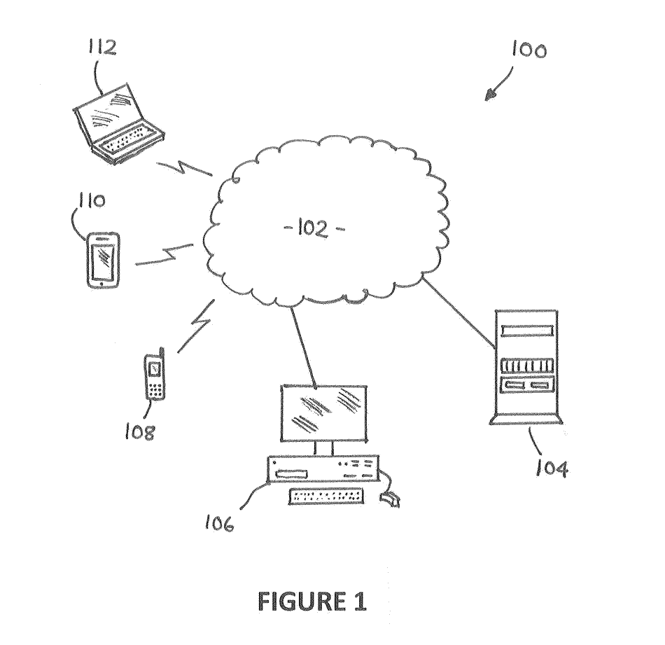

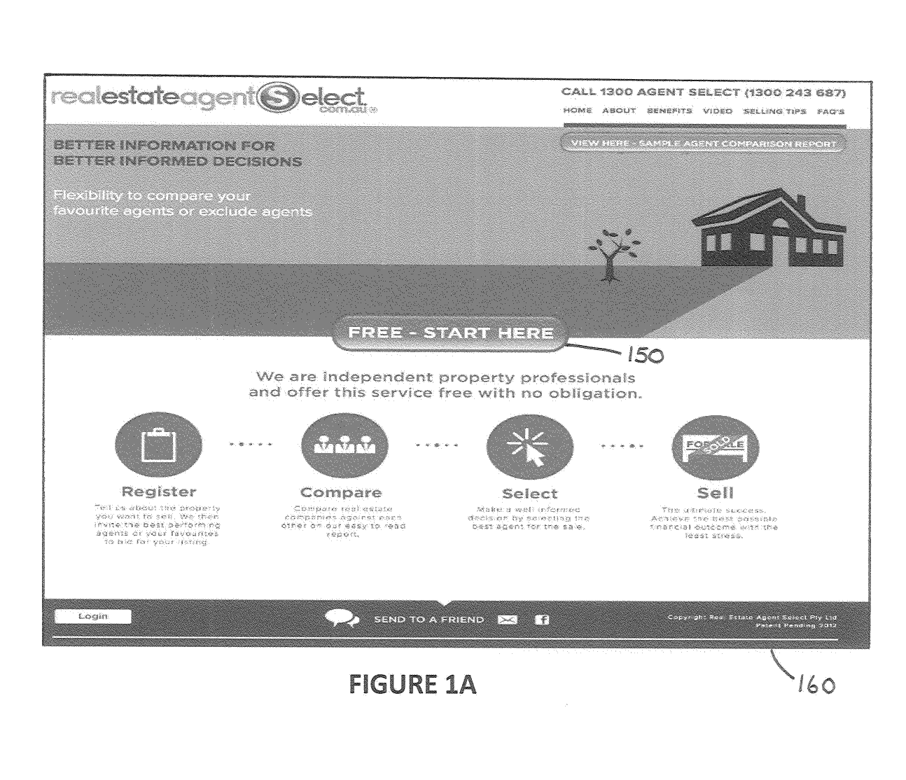

With reference to FIG. 1, there is shown a communication system (100) which is used to implement the invention according to one embodiment. The system (100) includes a communications network (102), such as the internet, to which is linked a server (104), desktop computing processor (106), and mobile computing processors (108, 110, 112) which can be for example a mobile telephone (108), smartphone (110) or laptop or tablet PC (112). Access to server (104) is through a website accessible by the internet (102) on any one of the devices (106 to 112).

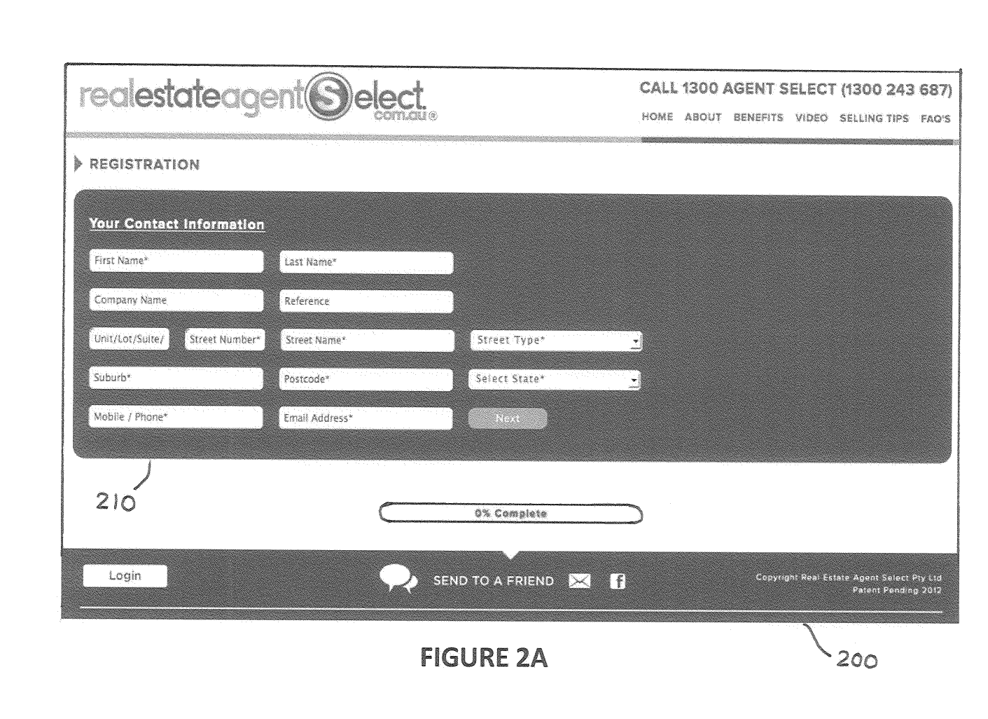

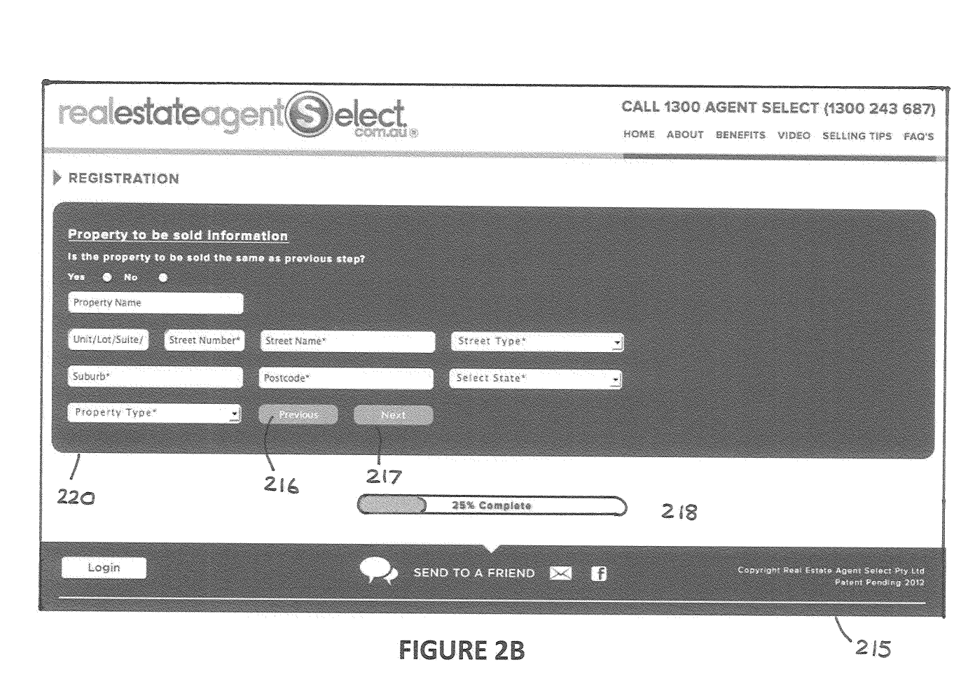

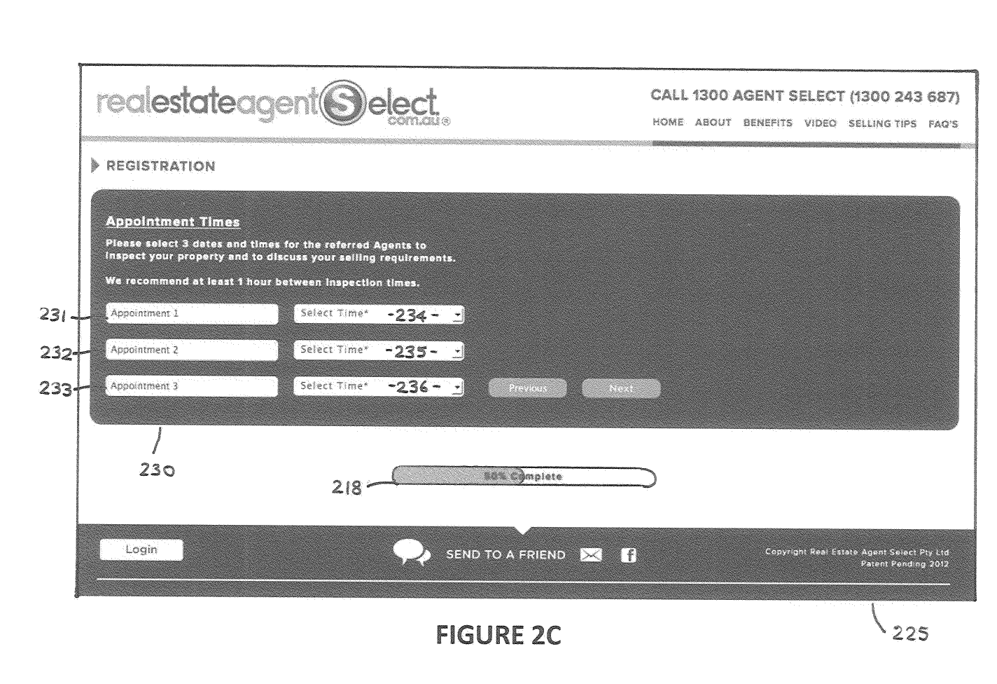

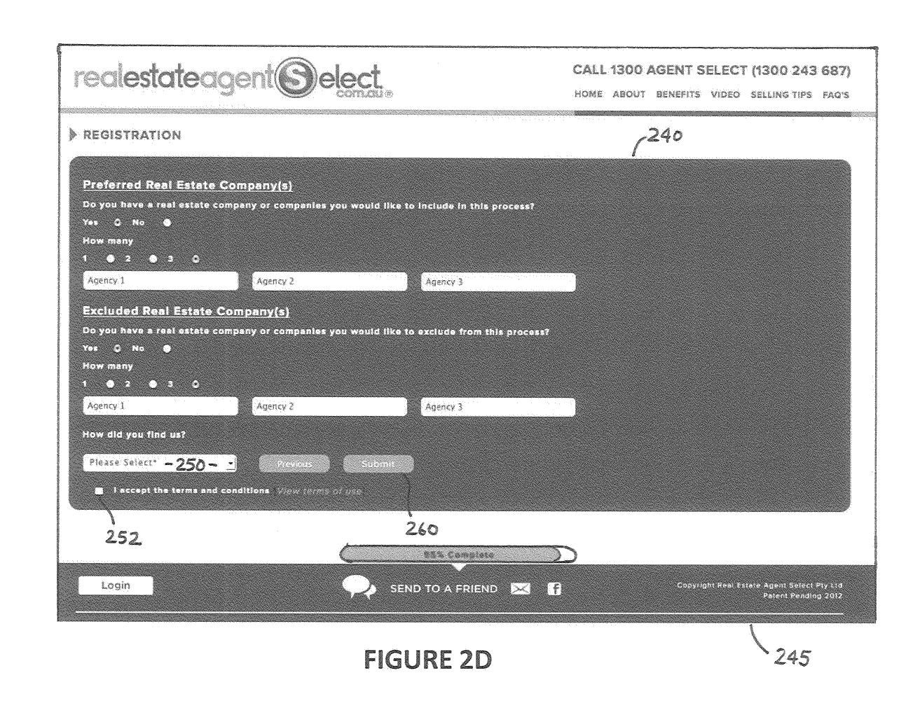

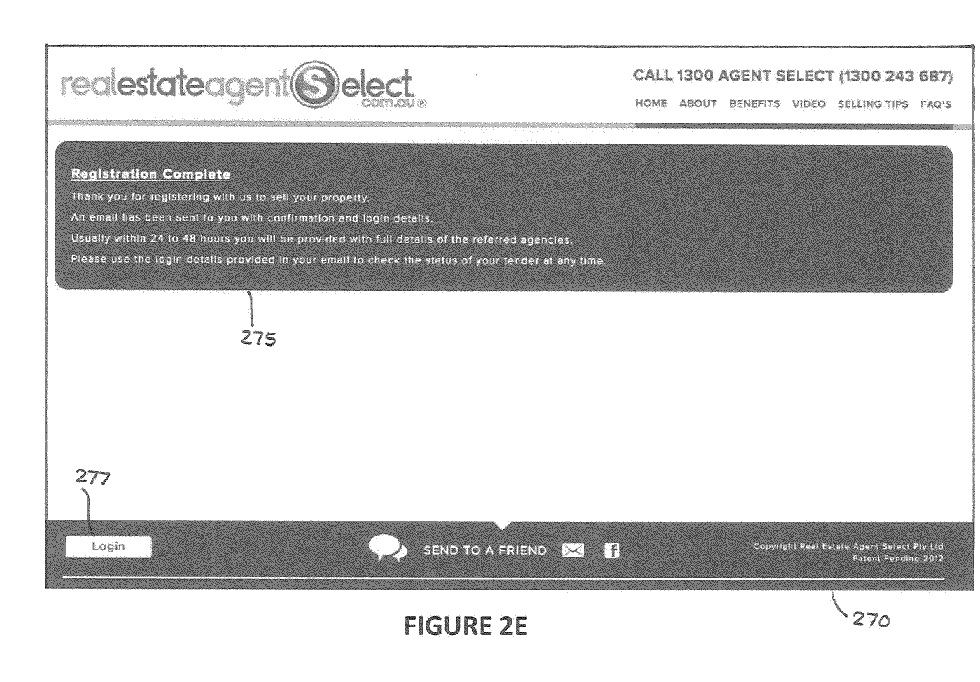

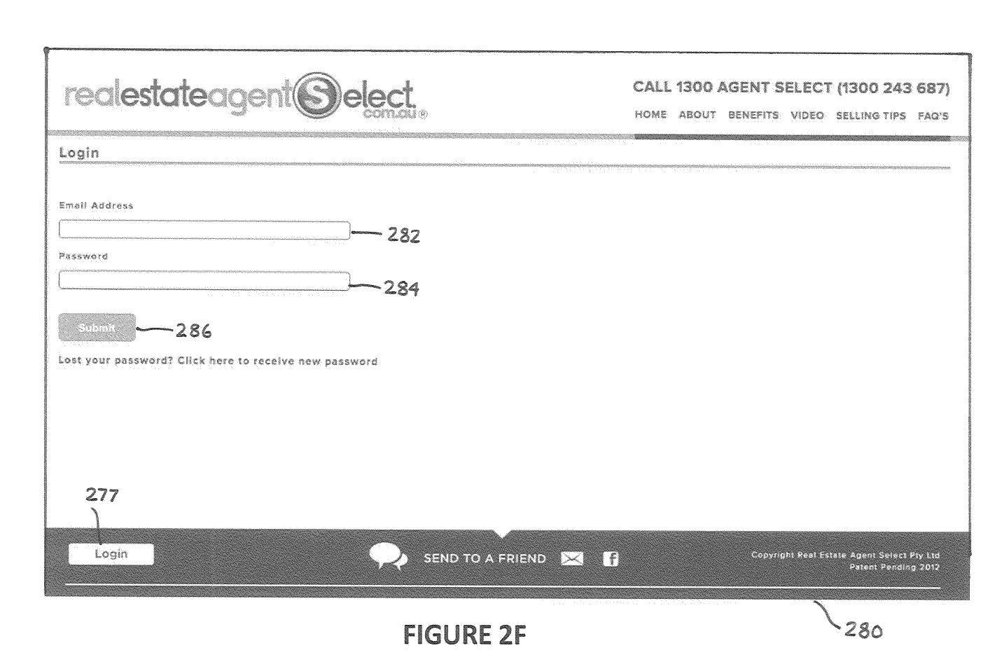

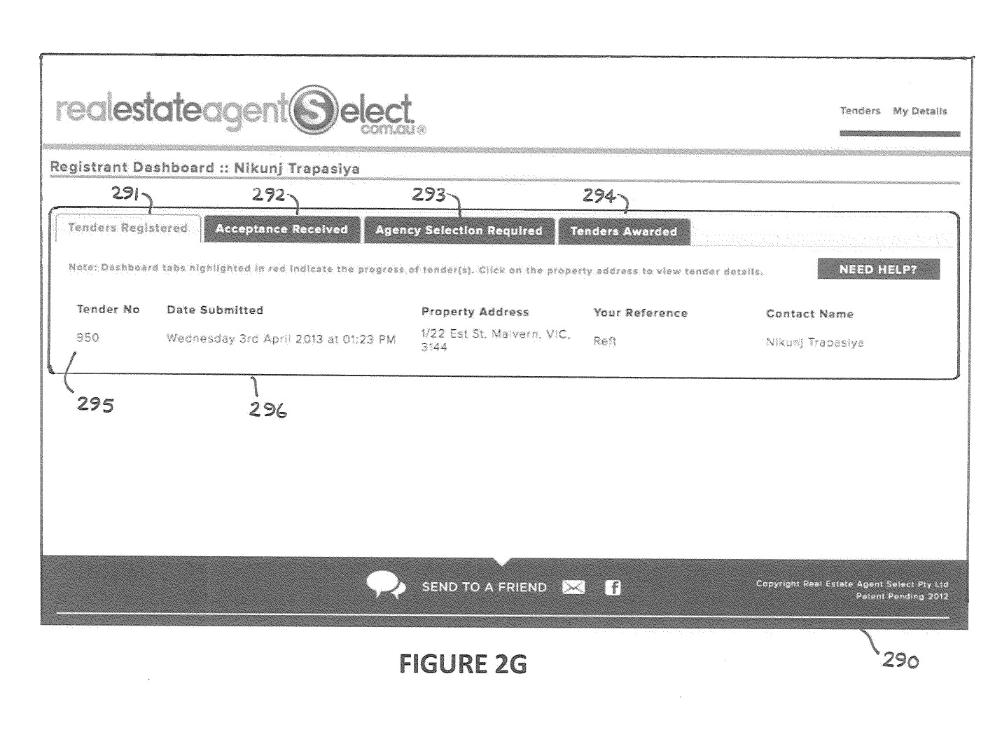

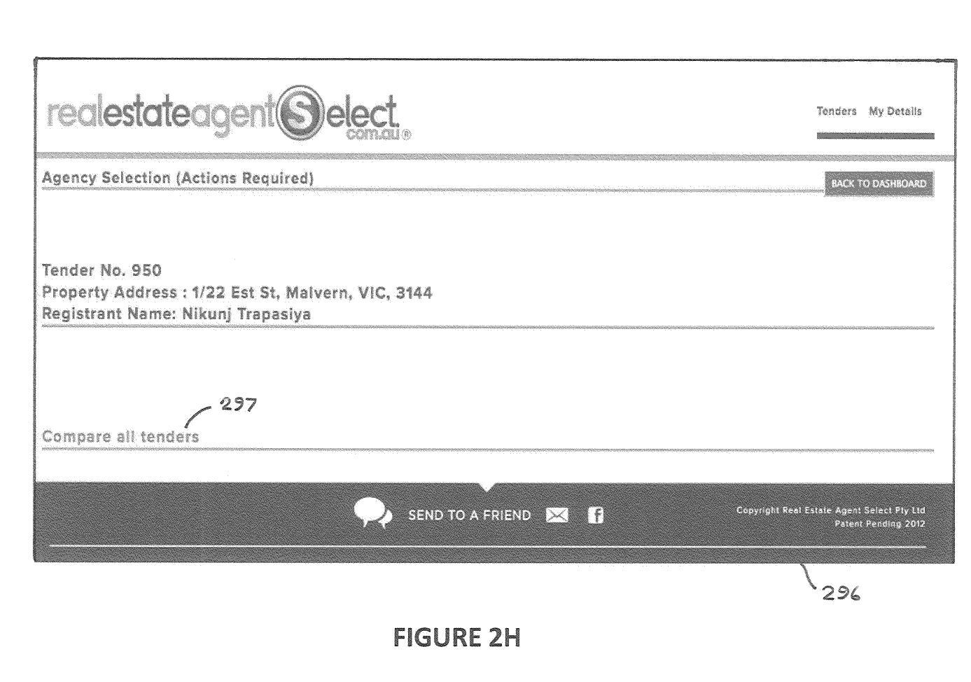

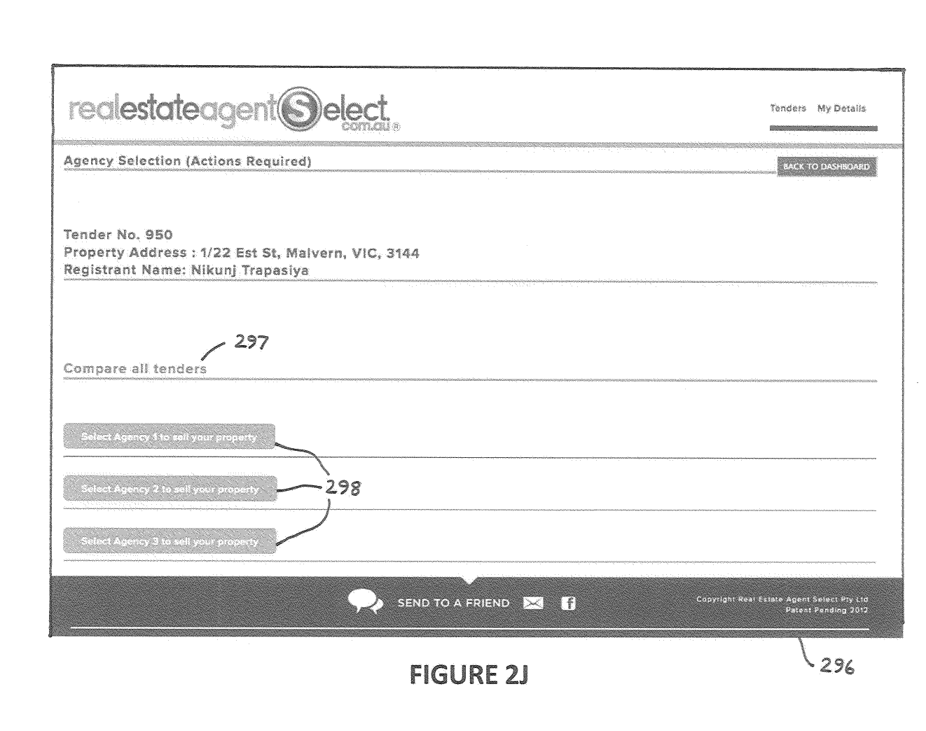

An individual user interested in selling an asset, such as property through a third party, who owns the server (104), accesses the website of the third party and registers. The third party is usually an organisation or representative experienced in the particular asset being sold. The user is typically a vendor or a representative of the vendor and hereinafter may be referred to as a registrant. The user registers by clicking on “FREE—START HERE” button (150) which is accessible from the home page of the third party shown on screen (160) of FIG. 1A. A computer program stored in server (104) instructs a processor on server (104) to display pages as shown in FIGS. 2A to 2D. The pages provide an information entry means are used to register a vendor (seller) or vendor representative's and provides a number of boxes for the vendor or representative to complete. In box (210), shown on screen (200) in FIG. 2A, the registrant fills in his/her personal details such as first and last names, any company name, a reference and the address for correspondence together with a telephone contact, such as a mobile number, and an email address. The email address is important as most communications between the third party and the registrant will be by email. In box (220), shown on screen (215) of FIG. 2B, the individual provides details of the property name (if applicable), the address of the property to be sold and what type of property it is. The individual can toggle between the screens shown in FIGS. 2A to 2D by using PREVIOUS button (216) and NEXT button (217). A progress bar (218) shows the individual how far he/she has progressed in the registration process. The individual may be an investor or may be selling on behalf of the property owner and therefore may have a different address to the property being sold. In box (230), shown on screen (225) of FIG. 2C, the individual must select at least three dates in boxes (231), (232) and (233) and three corresponding times in boxes (234), (235) and (236) for referred agencies or real estate companies to visit the property and meet the vendor or representative.

In box (240), shown on screen (245) of FIG. 2D, the individual has an option to list any preferred or excluded real estate companies that they would like to add to or exclude from a tender invitation list. Boxes are provided for up to three additional preferred agents and up to three additional excluded agents. Once this is completed, the individual at section (250) may insert information about how they accessed or learnt about the third party website, agree to the terms and conditions by checking box (252), which terms and conditions are accessible on the website, and then click on the submit button (260) when the registration form is complete and is stored in memory at server (104).

Once submitted, the registration is stored in the memory of server (104) and the third party prepares to refer a minimum of two agents (which can be more if required) in the area of the property to be sold, taking into account any preferred or excluded real estate companies listed by the vendor. The third party can base the decision on which real estate company to use considering, but not limited to for example the postcode of the property and the agencies, the number of listings in the area by each agency, the number of properties that have been sold over a predetermined period of time and average number of days on the market for the various agencies. This information can be cross-checked through various other sources, including the internet. The third party may have access to a database listing various real estate companies and the performance record thereof.

Shown in FIG. 2G is a registrant dashboard screen (290) which is used by the registrant to observe and keep track of the process of selecting a real estate company. The computer program stored in server (104) instructs the server processor to display a page showing screen (290). The registrant is provided with a login ID and a password by the program to use in order to access the database and the registrant dashboard. There are four sections in the process to be followed by the registrant shown in box (296), being the tenders registered at button (291), acceptances received at button (292), agency selection required at button (293) and tenders awarded at button (294). At the bottom of box (296), there is shown at (295) information relating to a specific tender(s) of the registrant, under Tender number 950. Once the registration is complete the server (104) displays screen (270) shown in FIG. 2E to the registrant with an information box (275) and confirming the registration. Also in box (275) there is a message stating that an email has been sent to the registrant providing login details including an email address and password to be entered on screen (280) of FIG. 2F after clicking on Login button (277). The email address provided is entered in box (282) while the password is entered in box (284) and the registrant clicks on submit button (286) to enter the third party website to access the dashboard shown on screen (290). The message in box (275) also mentions that usually within 24 to 48 hours, details on the referred real estate companies will be provided. The registrant would then be notified by email as each tender is received from the referred real estate companies and when the tender is closed. It is then for the registrant to compare the various tenders, by clicking on agency selection required button (293), which displays the tenders, such as Tender No. 950 at (295). Clicking on the area (295) or on the hyperlink under “Property Address”, directs the registrant to screen (296) in s 2H and 2J. The registrant can view the tender(s) for each real estate company in detail, and make a comparison of each company, by clicking on link (297) “Compare All Tenderers”. Then the registrant selects a preferred real estate company to sell the property on the vendor's behalf, by clicking on one of the ‘select agency’ buttons (298), which is managed by the computer program at server (104).

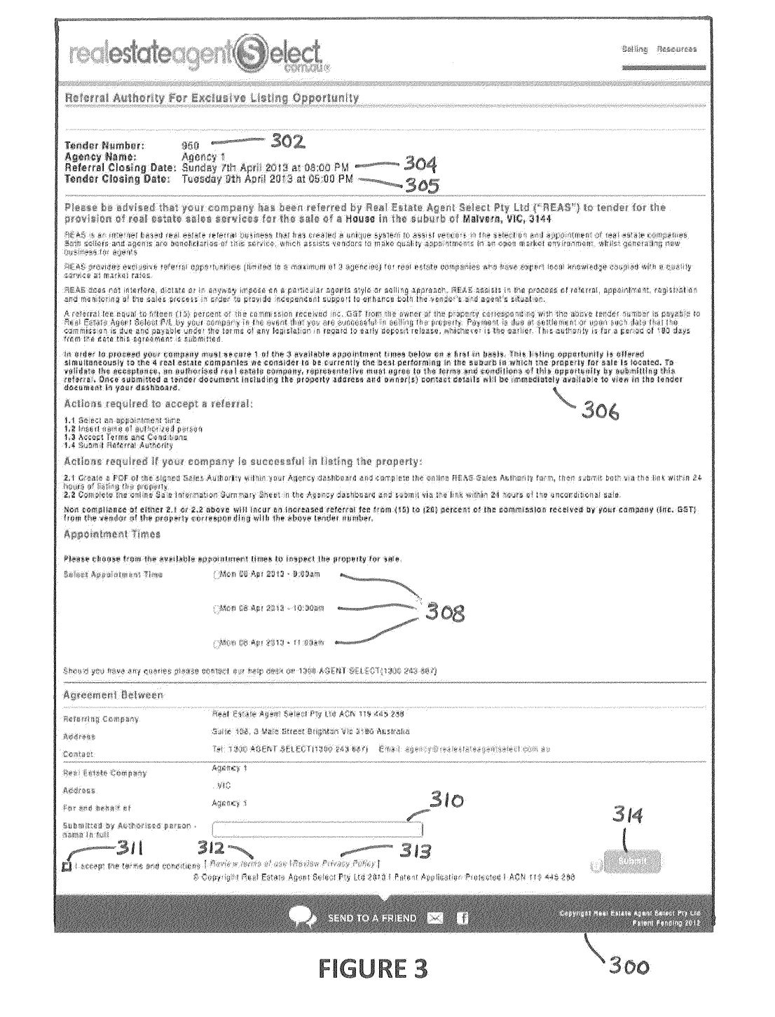

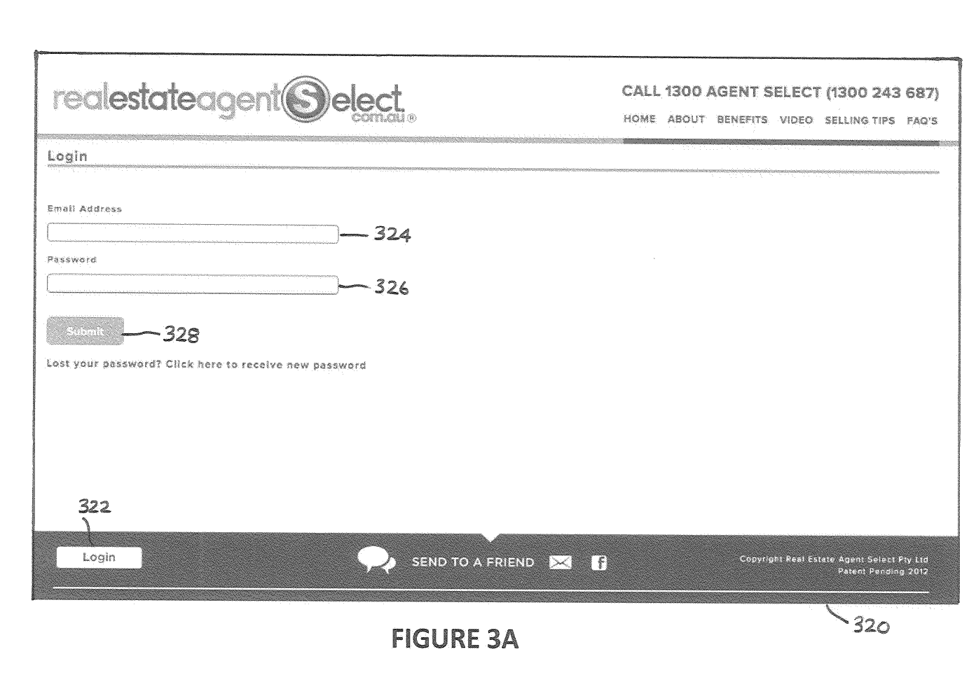

Prior to the process described in relation to FIG. 2G, a referral authority form shown in FIG. 3 is sent out by the third party to real estate companies that it has assessed and will refer, by email, in addition to any preferred real estate company nominated by the vendor. The authority form, in another embodiment, is provided by the server program and accessed through an agency dashboard screen (400). FIG. 3 shows a screen (300), accessed by clicking on a link to the website provided in the email, which discloses a tender number (302) and the closing date and time by which the referred real estate companies must respond at (304). A tender closing date is also shown at (305). Usually this is within 24 hours from the last inspection time. In section (306) the third party provides information about the organisation and what it does. The third party obtains a referral fee equivalent to a certain percentage of the commission received by the successful real estate company from the owner of the property, that is, the real estate company that has sold the property on behalf of the owner. Typically a referral fee may be around 15-20% of the commission. There is no payment from the vendor to the third party. In other words, access to the website is free and for the third party to refer real estate companies on behalf of the vendor, provide a unique comparison system and communicate between the successful agent and the registrant. In section (308) up to three times and dates are provided for the referred real estate companies to select an appointment time to meet the vendor or representative and inspect the property. There is an incentive for the particular real estate company to select the most appropriate time as quickly as possible, as other companies that are tendering for the sale of this particular property might prefer the same appointment time. At this stage only the type of property and the suburb where the property is situated is disclosed. No other details about the owner or property are provided. In box (310) the name of the authorised person acting on behalf of the real estate company is inserted. At box (312) the real estate company representative accepts the terms and conditions, by checking box (311), after reviewing the terms and conditions (link 312) and the privacy policy (link 313). Once the representative is satisfied with the form, the submit button (314) is pressed and the completed referral authority is sent back to server (104) by email (usually).

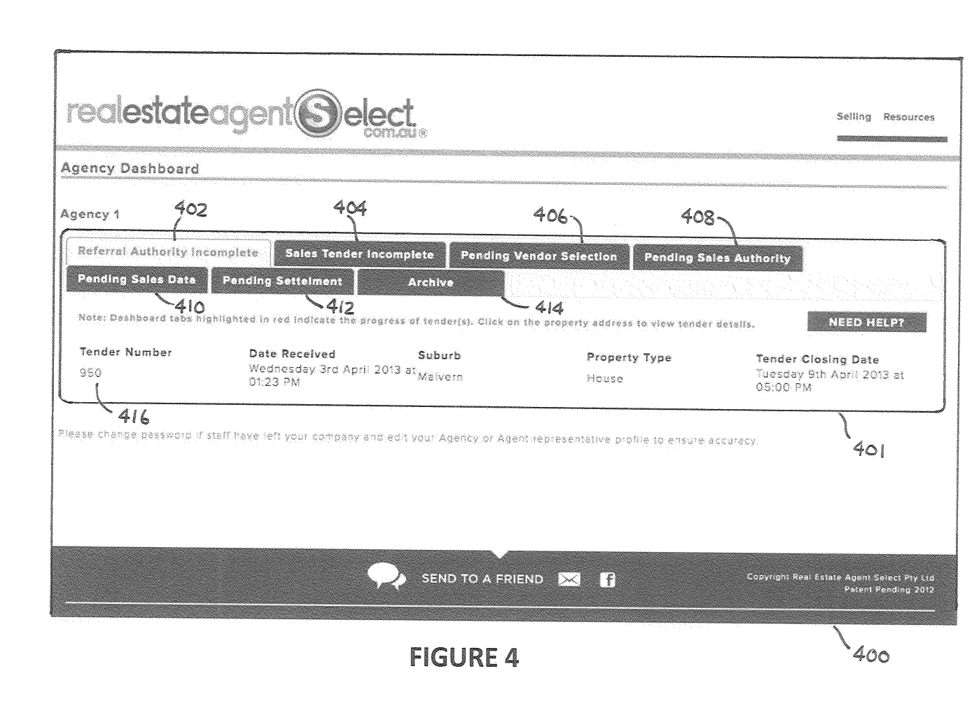

The referral authority is completed through the website of the third party. The real estate companies referred by the third party to respond to a tender are given a login email address and password by email, which the real estate company can respectively enter in boxes (324) and (326) on screen (320) in FIG. 3A after clicking on button (322), and clicking on submit button (328). The login and password can alternatively be sent to the referred companies in the original email sent by the third party to enable each referred company to access the agency dashboard shown on (400) in FIG. 4 and complete the referral authority by clicking on button (402) in box (401). After logging in, the real estate company is presented with screen (400) shown in FIG. 4. The screen (400) is an agency dashboard that provides links to the various steps in the process of being a successful tenderer to sell the property. Clicking on link (402) enables the referred real estate companies to complete the referral authority. Clicking on the link (402) will display a link (416) which provides details about the tender, specifically the tender number, the date it was received or sent to the real estate company, the suburb where the property is located, the type of property and also the closing date for the tender. Clicking on link (416) provides access to the referral authority form shown in FIG. 3. By completing and sending the referral authority back to the third party, the agent or agency is bound to deal directly with the third party and not the registrant, and if successful in tendering and selling the property, the agency must give the commission to the third party. This prevents each agency dealing exclusively with the registrant.

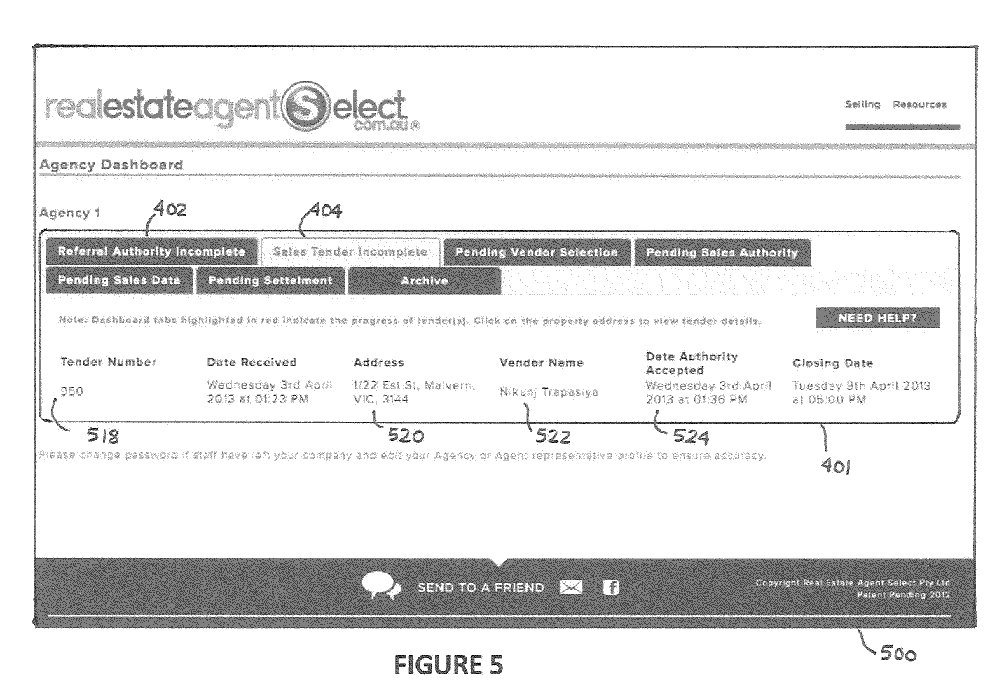

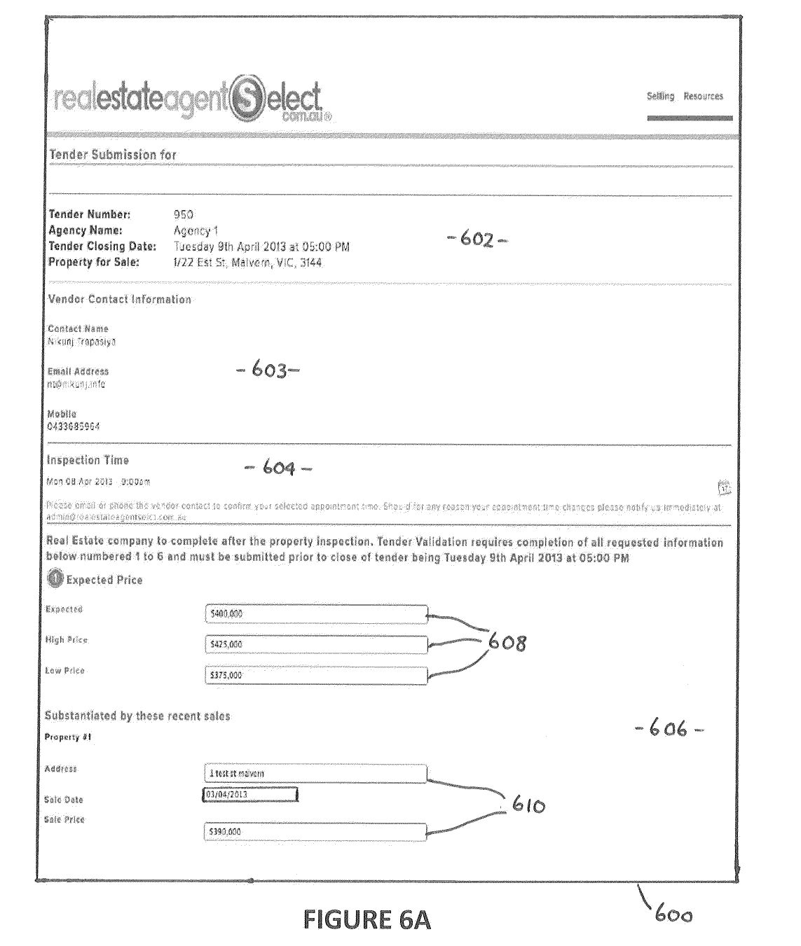

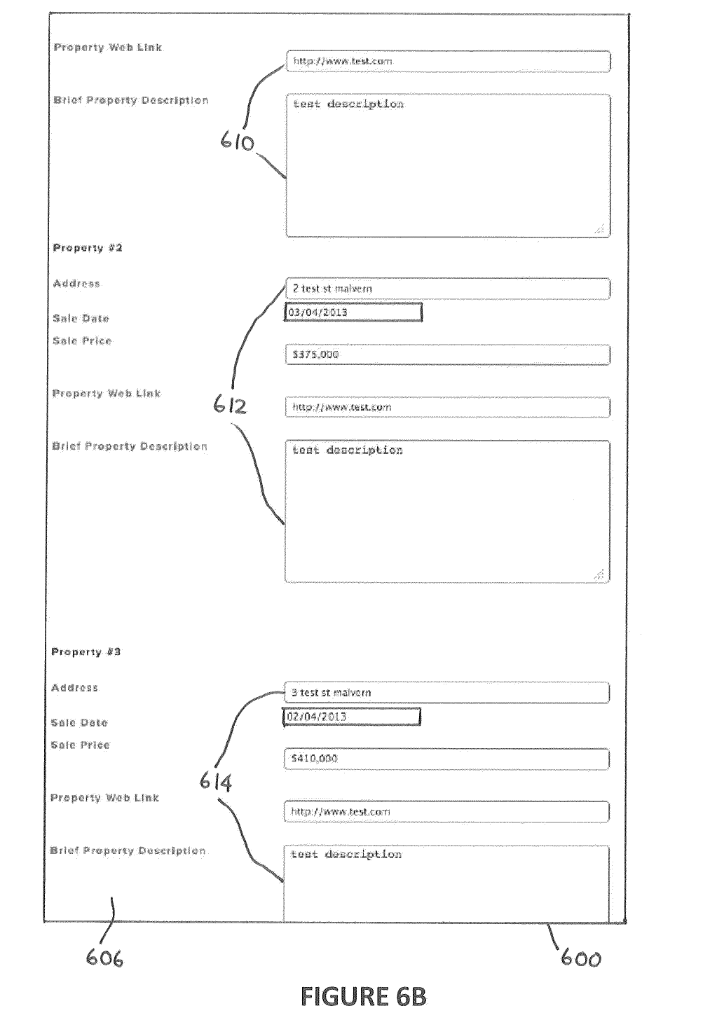

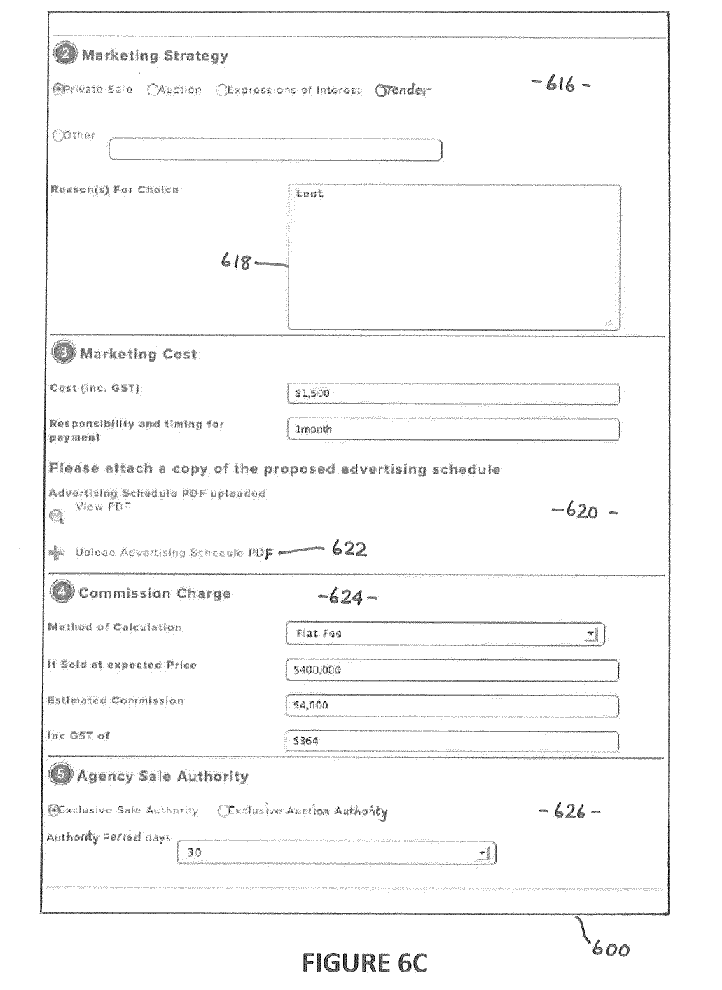

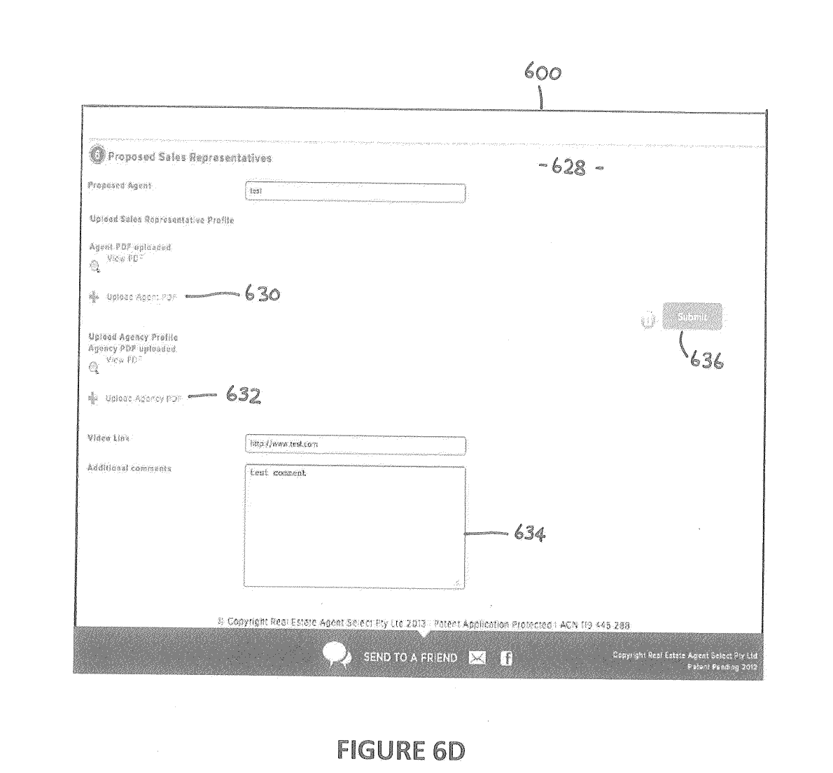

Once the referral authority form is received by the third party in the 24 hour period, a sales tender is either emailed (with a link) to each of the real estate companies that submitted referral authorities or it is accessed through the website through link (404) with each real estate company using the login and password assigned. When link (404) is depressed this shows the information on screen (500) in FIG. 5 where link (518) is provided by the server computer program and displayed with the actual address at (520), the name of the vendor or representative at (522) and the date that the authority was accepted at (524). Clicking on link (518) directs the respective real estate company to screen (600) in FIGS. 6A to 6D (which is all one screen view, page or snapshot) that provide a tender submission entry means. Alternatively real estate companies will fill out the forms in FIGS. 6A to 6D and return it to the third party through the link provided in an email. In FIGS. 6A to 6D there is shown screen (600), again provided by the server computer program, where in section (602) there is displayed the tender number, the name of the real estate company, the closing date for submitting the tender and the address of the property for sale. The details of the vendor, or representative, including name, email address and mobile phone number is also displayed in section (603). In section (604) the inspection time selected from the referral authority form is displayed. The respective agent would then visit the property and meet the vendor or representative to make an assessment on expected sale price and marketing strategy.

In section (606) there are various sub-sections to fill out and complete by the particular real estate company representative. In section (608) the real estate company representative estimates the expected selling price of the property. This all occurs after the agent has met with the vendor or representative at the scheduled time to view the property and both parties have had discussions. A high price, expected price and a low price are estimated and entered. In various boxes (610, 612, 614) the real estate company representative completes details of recently sold properties (comparative market analysis) including the address, the sale date and price, a website address of the agent and the description of the property. In section (616), the marketing strategy is entered, which in this case should be a tender marked with a bullet point. Other possible strategies are Private Sale, Auction, Expressions of Interest and Other. The reason for the choice of the marketing strategy is also entered in box (618). In box (620), the marketing costs are estimated and a proposed advertising schedule is prepared, typically in a ‘pdf’ document and uploaded through link (622). The liability and timing of the various payments for the advertising costs must be listed in the advertising schedule. In box (624), details on the commission charge is entered, which is a percentage of the purchase price or another figure. An example of the approximate commission charge is shown, based on a sale price. In box (626) the agent sale authority is identified as being either an exclusive sale authority or an exclusive auction authority and how long that authority lasts. Finally in section (628), details on the proposed real estate company sales representative responsible for the sale is included and the sales representative resume is uploaded at link (630) and an agency profile is also uploaded in ‘pdf’ form at link (632). Any additional comments can be entered in box (634). Completing the tender submission, the respective real estate company representative clicks on the submit button (636).

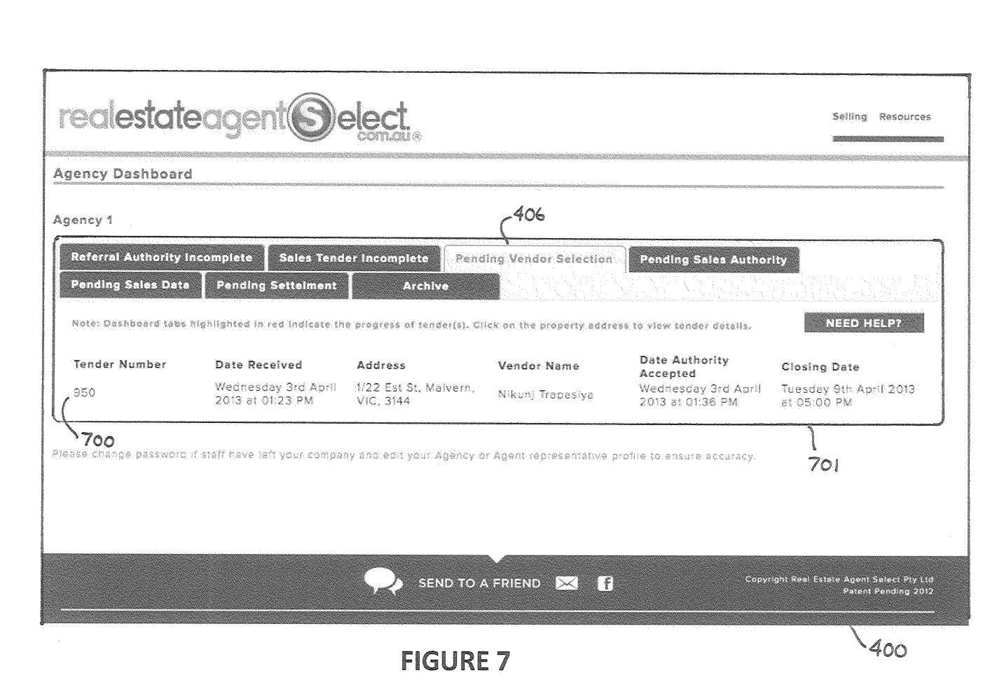

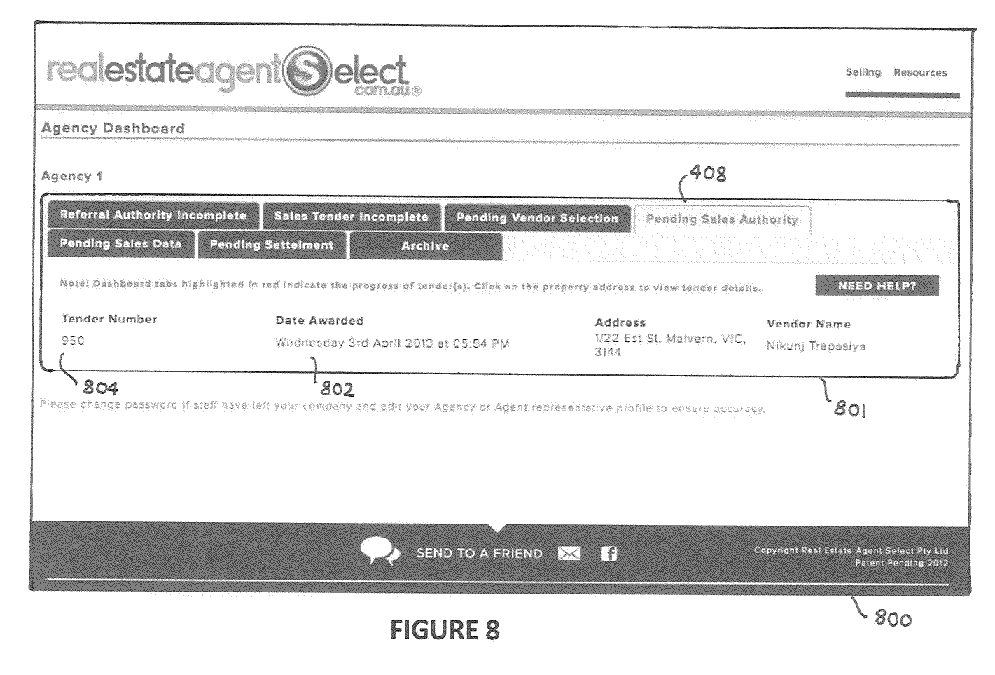

The tender submission is stored in memory at the website and is available to be viewed. The vendor or representative is notified by email from the third party, as each tender submission is completed from each referred real estate company that submitted a referral authority. The vendor or representative is able to view each of the tender submissions on dashboard screen (290) in FIG. 2G by clicking on link (293). Thus each of the sales tender documents supplied by the real estate companies is able to be viewed through the website by the vendor or representative. Once the vendor or representative has looked at each of the tenders from the respective real estate companies, the vendor or representative selects which agent they wish to use to sell his or her property by clicking on link (293) and selecting the preferred agent (FIG. 2J). The vendor or representative is able to see the various steps involved in the process through the dashboard screen (290). Once a successful real estate company is selected, that real estate company representative is then informed of the registrant's decision. This can be either done through email or through the agency dashboard shown on screen (400) where in FIG. 7 there is shown screen (400) and clicking on “pending vendor selection” button (406) (highlighted in red) displays the link (700) in box (701), provided by the program, which is the same as link (518) in FIG. 5. Clicking on link (700) the agent, which can be the real estate company representative or a realtor is presented with a screen similar to screen (600) shown in FIGS. 6A to 6D, provided by the server program. Then the representative of the real estate company, after having been informed of being the successful tenderer, clicks on the submit button (636) where the real estate company representative is reverted back to the agency dashboard screen (400) and highlighted in red is “pending sales authority” button (408) shown in FIG. 8. Clicking on button (408) in FIG. 8 displays the link (804) in box (801) of screen (800), facilitated by the program, which confirms that the particular real estate company has been successfully awarded the opportunity to sell the vendor's property. This is indicated under the date awarded (802) of link (800).

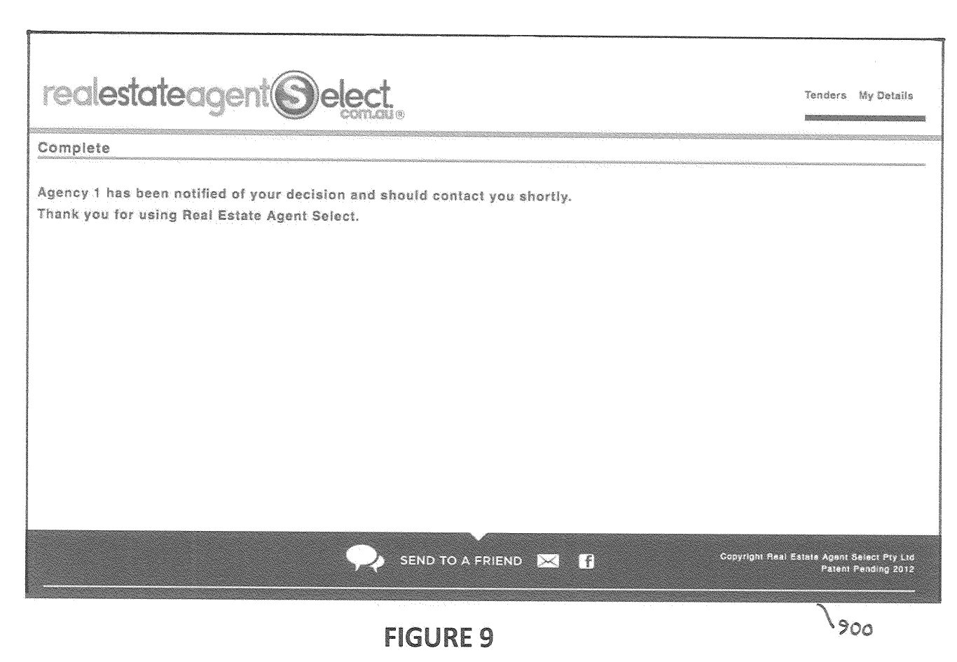

In FIG. 9 there is shown screen (900) provided from server (104) which is sent to or is accessed by the registrant, informing the registrant that the successful real estate company has been notified and will contact the vendor to proceed with the sale of the property.

The unsuccessful real estate companies that tendered are also informed by email that they are unsuccessful for that particular property or alternatively find out through button (406). The successful real estate company then has a limited time to prepare and transmit the sales authority using the agency dashboard through button (408). The authority is usually created as a ‘pdf’ document and is completed online through the website.

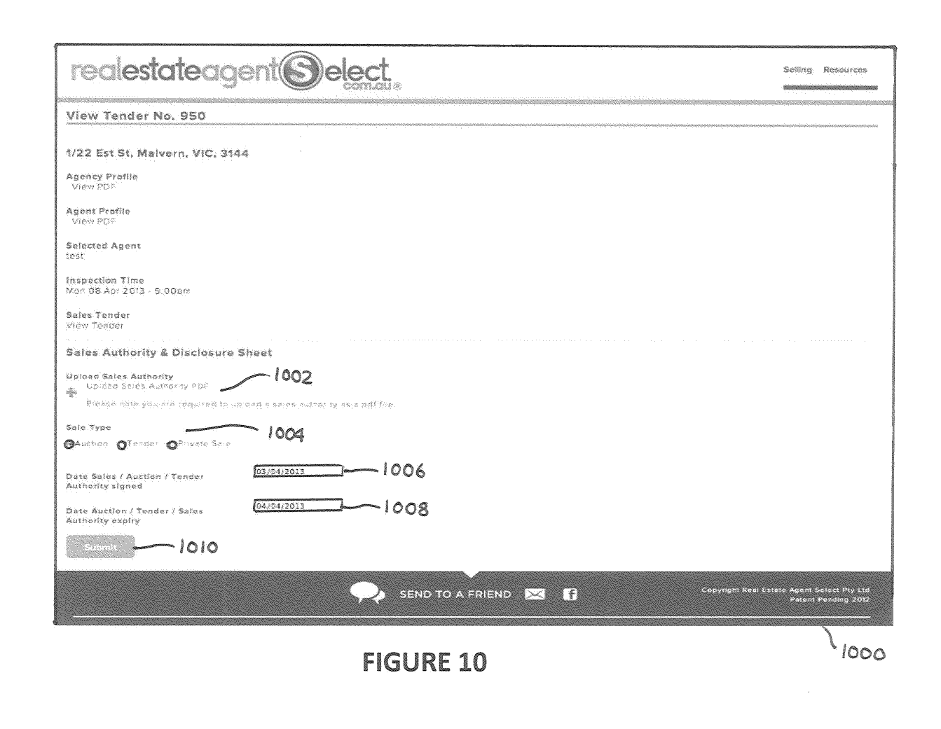

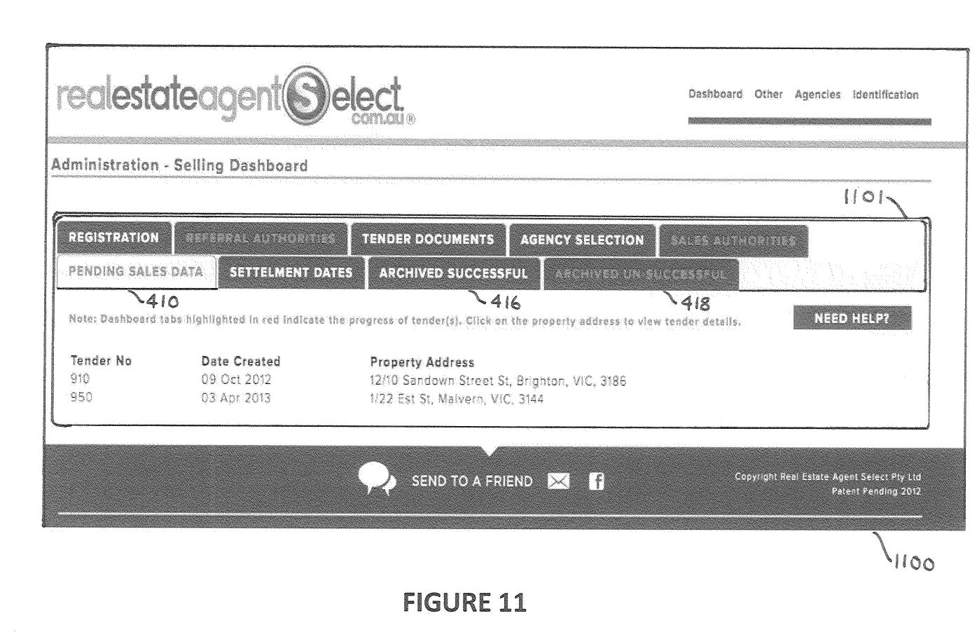

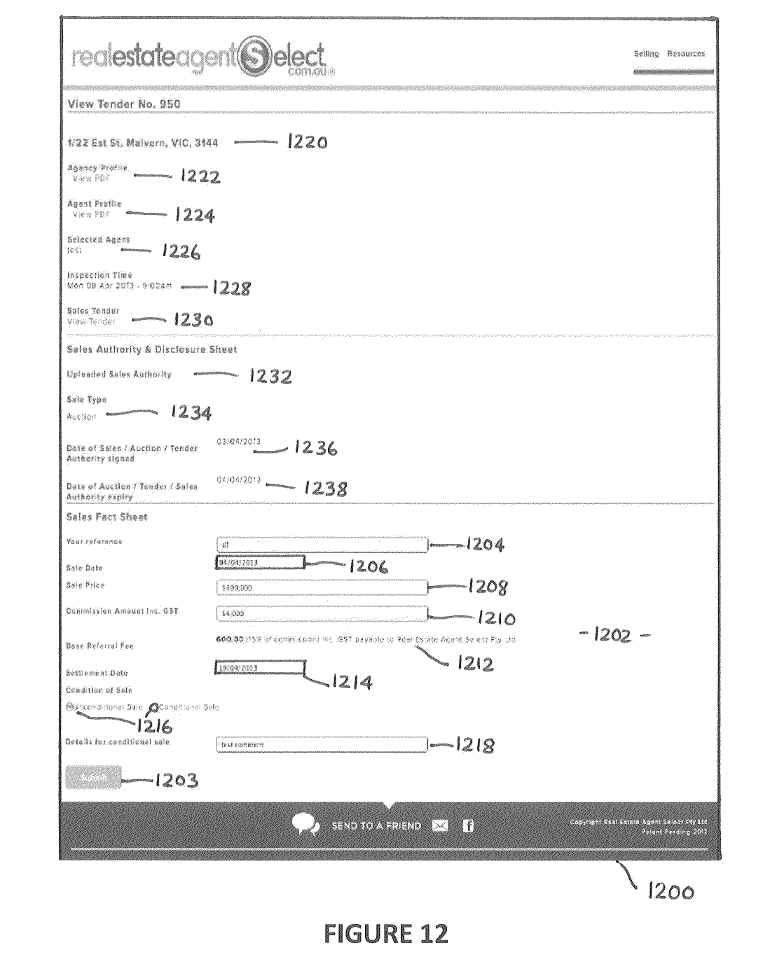

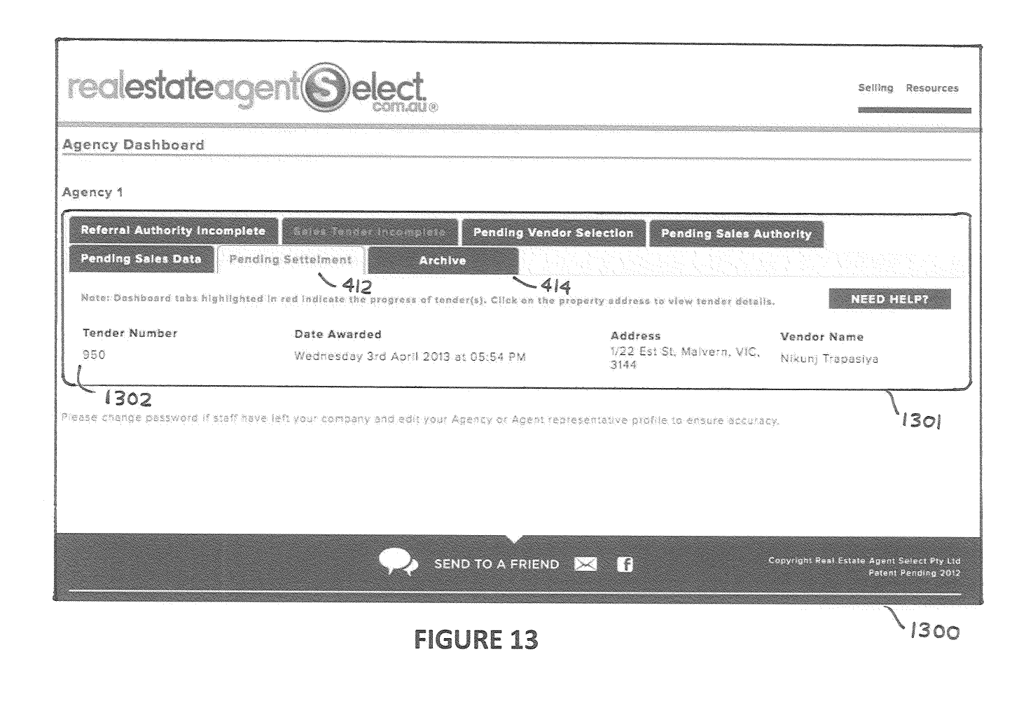

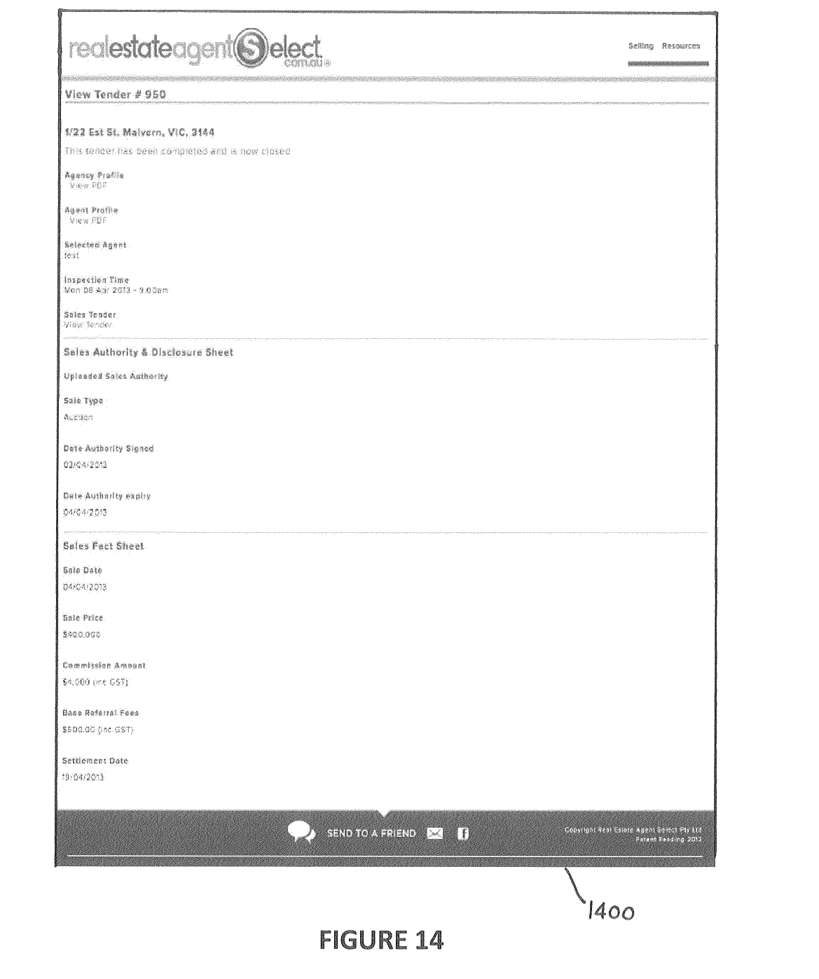

Referring to FIG. 10 there is shown a screen (1000) provided by the server computer program which is accessed by clicking on button (408) “Pending Sales Authority” where the successful tenderer can view or upload certain information. For example the signed sales authority is uploaded and is able to be viewed at link (1002), the sale type is disclosed at (1004) through one of the buttons shown, the date of the auction is entered at box (1006) and the sales authority expiry date is entered at box (1008) and then the real estate company representative clicks the submit button (1010). The process then involves button (410), which is highlighted in red, shown in box (1101) on screen (1100) in FIG. 11 where the real estate company representative clicks on this button to display the various tender numbers that agent or agent representative is responsible for and has successfully tendered. Shown are tender numbers 910 and 950 which each have a link that can be clicked on to provide further details. Clicking on the link to tender number 950 provides screen (1200), provided by the program, shown in FIG. 12. The information entered on screen (1000) of FIG. 10 is confirmed and replicated on screen (1200). This includes the address of the property (1220), the agency profile (1222) accessible through a link to a PDF, the agent profile (1224) accessible through a link to a PDF, the selected agent (1226), the inspection time (1228), the sales tender (1230) viewable through a link, a link to the uploaded sales authority (1232), the sales type (1234), the date of the auction (1236) and the sales authority expiry date (1238). Information about the sales fact sheet is shown in section (1202). Additional details entered include a reference (box 1204), date of sale (box 1206), the sale price (box 1208), commission percentage at (1212), commission amount including GST (at box 1210), the proposed settlement date (box 1214), the condition of sale at buttons (1216) and any other details associated with the conditional sale at box (1218). Once this information is input the real estate company representative clicks on submit button (1203) in which case the representative is reverted back to the agency dashboard screen (1300) shown in FIG. 13 which now highlights in red the pending settlement button (412) in box (1301). Clicking on button (412) produces a link below to tender number 950, which is then clicked to access the screen (1400) shown in FIG. 14, confirming that the tender has been completed and is closed. This confirms the information shown or entered on screen (1200) of FIG. 12. Archive button (414) provides access to all tenders stored in the server memory. Alternatively, an archived successful button 416 and an archived unsuccessful button 418 in FIG. 11 can be depressed to access information on stored successful and unsuccessful tenders or tenderers.

The sales authority form is submitted on the website within 24 hours of listing the property. The referral fee should be clearly disclosed on the sales authority form. A sale information summary sheet on the agency dashboard (400) must also be completed and submitted online through the website within 24 hours of an unconditional sale of the property.

Non-compliance of either of the above submissions will incur an increased commission charge from an initial amount, for example 15%, to an increased amount, say 20% of the commission received from the owner and payable to the third party (including GST where applicable).

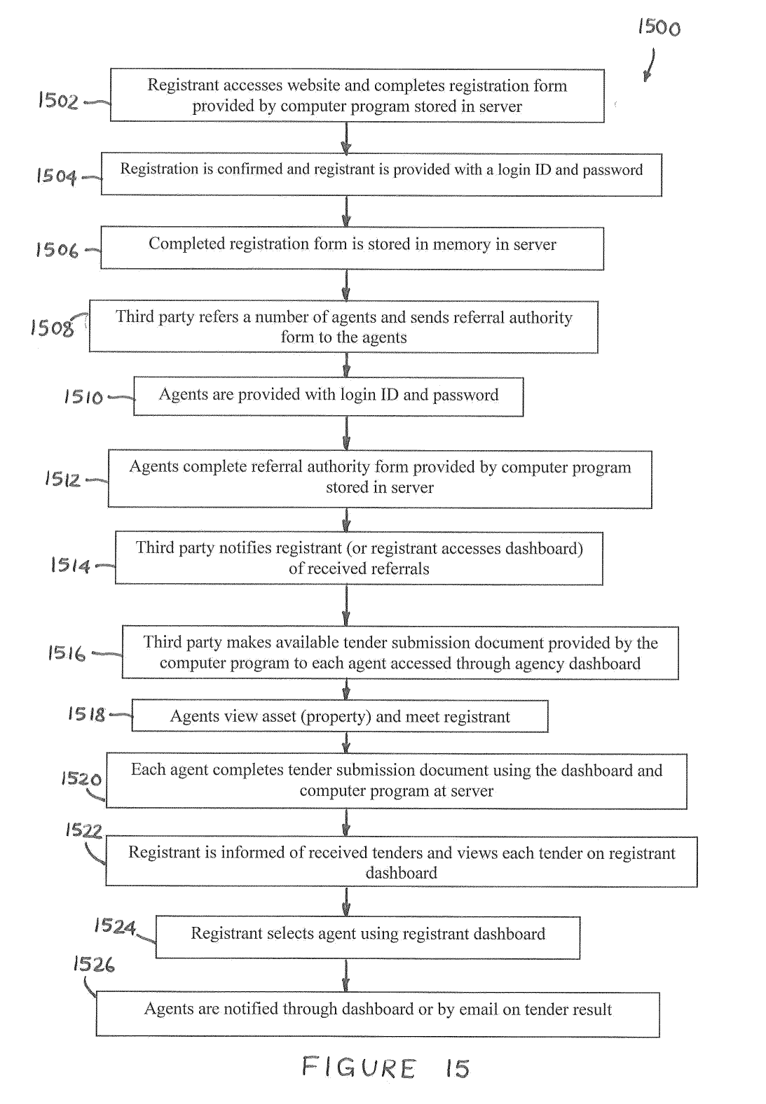

Referring to FIG. 15 there is shown a flow diagram (1500) of the process involving a registrant selecting a real estate company to sell an asset using the website stored at server (104) of a third party. At step (1502) the registrant accesses the website and completes a registration form which is provided by a computer program stored in the server (104). At step (1504) the third party confirms the registration and provides the registrant with a login ID and password to access a registrant dashboard on the website which is also provided by the computer program. At step (1506) the registration form is stored in memory at server (104) and is accessible by the registrant and the third party.

At step (1508) the third party refers a minimum of two real estate companies to confirm that they are interested in selling the asset and sends a referral authority form, typically by email with a link to the website and the referral authority form. The referrals can be automated and/or be selected by the third party based on a number of criteria. A manual crosscheck using the database can be performed to check the selections made by the third party or registrant (preferred agents). At step (1510) each of the real estate companies are provided with a login ID and password and at step (1512) complete the referral authority form provided by the computer program. This enables each of the real estate companies to access an agency dashboard to view the status of the process in the registrant accepting one of the referred real estate companies. At step (1514) the third party notifies the registrant of the received referral forms or provides these on the registrant dashboard. At step (1516) the third party enables access to a tender submission document provided by the computer program to each real estate company, which is accessed through the agency dashboard on the website. Thus the tender document is made available only to agents or agencies that agree to the terms and conditions of the referral authority and submit it from the agency dashboard. At step (1518) the real estate companies view the property after arranging to meet the registrant at a certain time and date. At step (1520) each agent real estate company completes the tender submission document using the dashboard under the instructions from the computer program which is stored on server (104).

At step (1522) the registrant, after the agents have completed the tender submissions, is informed of the received tenders and views these on the registrant dashboard. At step (1524) the registrant makes a decision upon reviewing each of the tender submissions and selects a real estate company using the registrant dashboard. The third party is then notified as is the successful real estate company, through the agency dashboard or by email, and the other real estate companies that tendered are informed of their unsuccessful tender at step (1526).

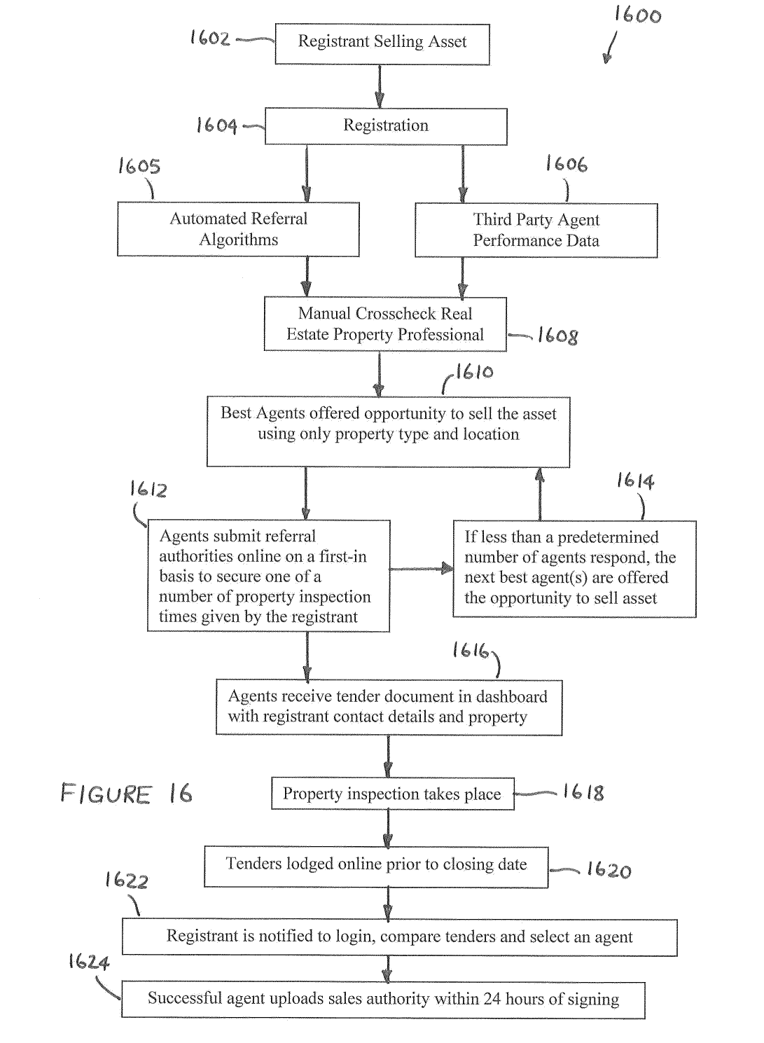

In a further embodiment to the process shown in FIG. 15, a registrant can select a real estate company to sell an asset using the process shown in FIG. 16. There is shown a further flow diagram (1600) whereby at step (1602) the registrant decides to sell an asset, such as real estate. The registrant can be the owner or a person/party authorised by the owner. At step (1604) the registration process takes place, as described with reference to FIGS. 2A to 2D. Automated referral algorithms can be used at step (1605) and/or performance data on various agents/agencies is selected by the third party using a third party database storing information on a plurality of agents and agencies (at step 1606). After selecting for example the four best or most suitable agents/agencies via steps (1605) and (1606), a manual cross check by a real estate property professional (or the third party) is performed at step (1608).

At step (1610) the best agents or agencies, based on criteria and crosschecks, are offered the opportunity to sell the asset given the property type and the location of the asset. The offered or referred agencies are determined by factors such as, but not limited to, property type, price and location. There is optional flexibility for the registrant to include preferred agent or agencies and/or exclude certain agents or agencies form the tender. Information provided to the agents or agencies is limited to property type and the location/suburb of the property to be sold and each must a decision to participate at this stage. The agents offered the opportunity submit a referral authority form online at step (1612) on a first-in basis to secure a property inspection time submitted by the registrant during the registration process at step (1604). If, at step (1614), less than three (or another designated number) responses are received within the required time, one or more next best agents are invited to vie to sell the asset. The process then returns to step (1610).

Where enough agents submit a referral authority form at step (1612), each agent receives a tender document at step (1616) in the agent dashboard with contact details of the registrant and the address of the property. The tender document is received immediately upon submitting the respective referral authority, providing the registrant contact details and the address of the property for sale. At step (1618) the property is inspected and at step (1620) the tender from each agent is lodged online prior to the closing date. At step (1622), the registrant is notified to login to the registrant dashboard, compare the tenders and select an agent to sell the asset. At step (1624) the successful agent uploads the sales authority within 24 hours of accepting to sell the asset.

The overall process described above commits a real estate company, through terms and conditions, and compliance with the whole process to better ensure that the property has a greater chance of being well-marketed and sold for a maximum price in an appropriate time frame.

The application is written in PHP, however any other suitable programming language may be used.

I claim:

1. A method of selecting an agency using a computer-based network to sell a property asset of a vendor or vendor representative, the method including the steps of:
obtaining information from the vendor or representative about the asset using information entry means available from a server in the computer-based network and storing the information on the server;
referring a plurality of agencies in the vicinity of the location of the property asset to be sold;
enabling the referred agencies to assess the value of the asset;
obtaining a tender submission from the referred agencies using tender submission entry means available from the server in the computer-based network;
enabling the vendor or representative to review each tender submission; and
the vendor or representative selecting an agency from the referred agencies to sell the asset based on the reviewed tender submissions.

2. A method according to claim 1 wherein the obtaining information step includes the provision of the location of the asset and the vendor or representative contact details.

3. A method according to claim 1 wherein the obtaining information step includes one or more agencies chosen by the vendor or vendor representative to be a referred agency.

4. A method according to claim 2 wherein the obtaining information step further includes the provision of a plurality of appointment times and dates for a representative or agent of the referred agencies to visit the vendor and assess the asset.

5. A method according to claim 4 further including forwarding a referral authority to each of the referred agencies for completion by said respective representative or agent of each of the referred agencies within a predetermined period of time.

6. A method according to claim 5 wherein each referred agency commits to one of a number of available dates and times determined by the vendor or vendor representative on the referral authority to visit the vendor or vendor representative and assess the asset.

7. A method according to claim 4 wherein the referral authority discloses the type of asset and the general location of the asset only to each of the referred agencies.

8. A method according to claim 1 wherein the tender submission includes the full address of the location of the asset and the vendor contact details or vendor representative contact details.

9. A method according to claim 8 wherein the tender submission includes the confirmed date and time for the respective referred agencies to visit the vendor or vendor representative.

10. A method according to claim 8 wherein the tender submission includes information on recent sales of similar assets to said asset, a marketing strategy, a marketing cost and expected sale price of the asset.

11. A method according to claim 1 including providing a first dashboard to enable the vendor or vendor representative to access information from the server leading to the selection of the agency from the plurality of agencies.

12. A method according to claim 1 including providing a second dashboard to enable the plurality of referred agencies access to the server to complete the tender submission and obtain information leading to the selection of the agency by the vendor or vendor representative.

13. A method according to claim 1 wherein the selected agency submits information within a predetermined time period to a third party responsible for the server, said information including a signed sales authority and a completed sales authority form.

14. A method according to claim 13 wherein the selected agency submits a sale information summary sheet to the third party within a predetermined time period of an unconditional sale of the property asset.

15. A method according to claim 13 wherein failure to submit said information or said sale information summary sheet within the predetermined time period incurs a financial penalty by the selected agency payable to the third party.

16. A method according to claim 15 wherein the penalty is an increase in the percentage of commission received by the selected agency from the vendor or vendor representative.

17. A method according to claim 1 wherein the agency is a real estate company and the agencies are real estate companies.

18. A computer program, when executed on a processor, in a method of selecting an agent to sell a property asset of a vendor or vendor representative, instructs the processor to:
provide information entry means for the vendor or vendor representative to provide information about the asset;
store the information;
provide a tender submission entry means for referred agencies from a plurality of agencies to complete a tender submission related to the property asset;
enable the vendor or vendor representative to review each tender submission;
wherein the vendor or vendor representative selects an agency from the referred agencies to sell the property asset based on the reviewed tender submissions.

19. Computer program according to claim 18 wherein the information entry means includes the provision to enter of the location of the asset and enter the vendor or representative contact details.

20. Computer program according to claim 18 wherein the information entry means includes the provision to enter one or more agencies chosen by the vendor or vendor representative to be a referred agency.

21. Computer program according to claim 20 wherein the information entry means includes the provision to enter a plurality of appointment times and dates for a representative or agent of the referred agencies to visit the vendor and assess the asset.

22. Computer program according to claim 21 further including instructing the processor to provide a referral authority for each of the referred agencies to complete by a respective representative or agent of each of the referred agencies within a predetermined period of time.

23. Computer program according to claim 18 further including instructing the processor to provide a first dashboard to enable the vendor or vendor representative to access information leading to the selection of the agency from the plurality of agencies.

24. Computer program according to claim 18 further including instructing the processor to provide a second dashboard to enable the plurality of referred agencies to complete the tender submission and obtain information leading to the selection of the agency by the vendor or vendor representative.

25. Computer program according to claim 18 wherein the agency is a real estate company and the agencies are real estate companies.

26. A computer-based network used to select an agency to sell a property asset of a vendor or vendor representative, the network including:
a server having information entry means for enabling the vendor or vendor representative to enter information on the asset and register with the network;
said server having tender submission entry means enabling referred agencies from a plurality of agencies in the vicinity of the location of the property asset to provide a tender submission;
whereupon review of each tender submission by the vendor or vendor representative, the vendor or vendor representative selects an agency from the referred agencies to sell the property asset.

27. A computer program product for enabling selection of an agent to sell a property asset of a vendor or vendor representative, said computer program product including at least one computer-readable storage medium having computer-readable code portions stored therein, the computer-readable program portions having:
a first executable portion for providing information entry means for the vendor or vendor representative to provide information about the asset which information in subsequently stored;
a second executable portion for providing a tender submission entry means for referred agencies from a plurality of agencies to complete a tender submission related to the property asset;
a third executable portion for enabling the vendor or vendor representative to review each tender submission;
wherein the vendor or vendor representative selects an agency from the referred agencies to sell the property asset based on the reviewed tender submissions.

28. A computer-useable medium having a computer-readable program code embodied therein, said computer-readable program code adapted to be executed to implement a method of selecting an agent to sell a property asset of a vendor or vendor representative, by:
providing information entry means for the vendor or vendor representative to provide information about the asset;
storing the information;
providing a tender submission entry means for referred agencies from a plurality of agencies to complete a tender submission related to the property asset;
enabling the vendor or vendor representative to review each tender submission;
wherein the vendor or vendor representative selects an agency from the referred agencies to sell the property asset based on the reviewed tender submissions.
